(19) United States
(12) Patent Application Publication
(10) Pub. No.: US 2023/0308430 A1
(43) Pub. Date: Sep. 28, 2023

(54) EMBEDDING PROGRAMMING CODE IN AN ELECTRONIC MESSAGE

(71) Applicant: KNO2 LLC, Boise, ID (US)

(72) Inventor: Travis WHITE, Boise, ID (US)

(73) Assignee: KNO2 LLC, Boise, ID (US)

(21) Appl. No.: 18/180,238

(22) Filed: Mar. 8, 2023

Related U.S. Application Data
(60) Provisional application No. 63/318,151, filed on Mar. 9, 2022.

(51) Int. Cl. H04L 9/40

(52) U.S. Cl. CPC H04L 63/0823; H04L 63/0428; H04L 63/126

(57) ABSTRACT

A method for a receiver device to process programming code contained in an electronic message. The electronic message is received. A security check is performed, including determining whether a sender of the electronic message is an authorized sender and determining whether the sender is authorized to access one or more workflows identified by an address of the electronic message. On a condition that the security check passes, the programming code is parsed and the one or more workflows identified by the address of the electronic message are performed at the receiver device based on the programming code.

### CROSS-REFERENCE TO RELATED APPLICATIONS

This application claims priority to U.S. Provisional Pat. Application No. 63/318,151 filed on Mar. 9, 2022, which is incorporated herein by reference in its entirety.

### BACKGROUND

A typical method of sending executable programming code via a message (e.g., an electronic mail message) is to include the programming code as an attachment to the message (e.g., an executable file included as an attachment to a Secure/Multipurpose internet Mail Extensions (S/MIME) message). Unfortunately, security systems at the receiver’s end may flag the message or block it entirely if the attachment contains executable programming code.

Another method of sending executable programming code via a message involves creating a point-to-point connection between the sender and the receiver to exchange secure messages and programming code. Creating the point-to-point connection, however, requires architecture (e.g., specially developed software and/or hardware) on both the sender’s side and the receiver’s side to enable the connection.

There is therefore a need for a method and system to send executable programming code from a sender to a receiver without requiring special architecture on both sides of the connection.

### SUMMARY

A method for a receiver device to process programming code contained in an electronic message is described herein. The electronic message is received. A security check is performed, including determining whether a sender of the electronic message is an authorized sender and determining whether the sender is authorized to access one or more workflows identified by an address of the electronic message. On a condition that the security check passes, the programming code is parsed and the one or more workflows identified by the address of the electronic message are performed at the receiver device based on the programming code.

A receiver device for processing programming code contained in an electronic message includes a receiving component, a security component, and a parsing component. The receiving component is configured to receive the electronic message. The security component is configured to perform a security check, including determine whether a sender of the electronic message is an authorized sender and determine whether the sender is authorized to access one or more workflows identified by an address of the electronic message. The parsing component is configured to, on a condition that the security check passes, parse the programming code and perform the one or more identified workflows based on the programming code.

A non-transitory computer-readable medium storing instructions for execution by one or more processors to perform operations for processing programming code contained in an electronic message by a receiver device is described herein. The operations include receiving the electronic message; performing a security check, including determining whether a sender of the electronic message is an authorized sender and determining whether the sender is authorized to access one or more workflows identified by an address of the electronic message; and on a condition that the security check passes, parsing the programming code and performing the one or more workflows identified by the address of the electronic message at the receiver device based on the programming code.

### BRIEF DESCRIPTION OF THE DRAWINGS

The accompanying drawings, which are incorporated in and constitute a part of this disclosure, illustrate several embodiments and aspects of this disclosure, and together with the description, serve to explain certain principles of the invention.

FIG. 1 illustrates an exemplary operating environment for implementing disclosed embodiments.

FIG. 2 illustrates a block diagram of an exemplary computing system for implementing disclosed embodiments.

FIG. 3 is block diagram of a system configured to process programming code in an electronic message.

FIG. 4 is a flowchart of a method for processing programming code in f an electronic message.

FIG. 5 is a flow diagram of an exemplary method of processing programming code in an electronic message for creating electronic documents for a patient’s signature.

### DETAILED DESCRIPTION

Reference will now be made in detail to exemplary embodiments, examples of which are illustrated in the drawings. The following description refers to the accompanying drawings in which the same numbers in different drawings represent the same or similar elements unless otherwise represented. The following implementations are merely examples of apparatuses, systems, and methods consistent with aspects related to subject matter in the appended claims.

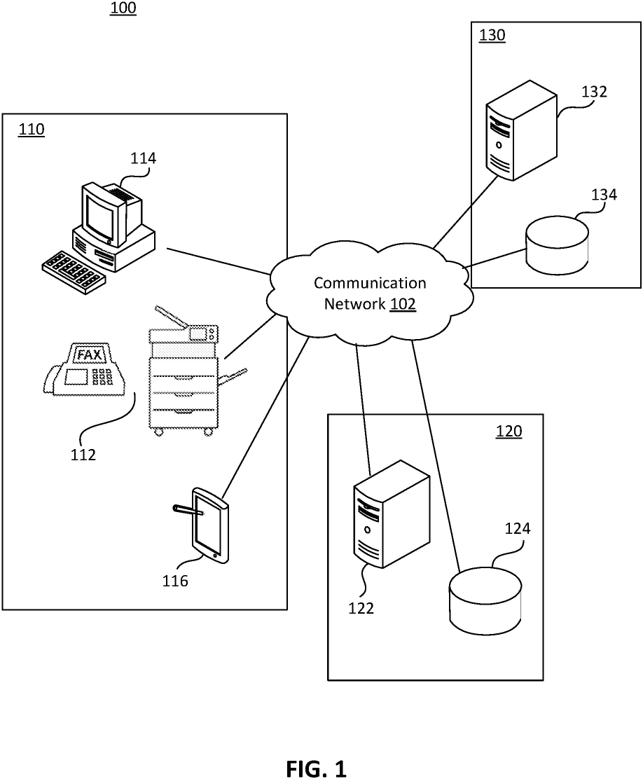

FIG. 1 illustrates an exemplary operating environment 100 for implementing disclosed embodiments. In a healthcare environment, the exemplary operating environment 100 may include a healthcare sub-network 110, a healthcare network server 120, a health information exchange (“HIE”) 130, and a communication network 102. A healthcare sub-network refers to a virtual or physical network containing devices used in healthcare facilities participating in a data exchange with other HIEs via a healthcare network server. A healthcare facility may include an appropriate healthcare organization, such as a hospital, a clinic, a laboratory, or a medical center. In different environments, the sub-network and server may have different names but perform similar functions.

The devices in healthcare sub-network 110 may include appropriate data-capturing, data-processing, or data-management devices, such as a computer, a digital camera, a network scanner, a printer, a fax server, a medical device, a smart phone, or any device having computing functionalities. The devices in the healthcare sub-network 110 may include off-the-shelf multi-function devices running software programs for performing needed data-management processes or may be customized or customizable multi-function devices capable of performing those data management functionalities.

Healthcare sub-network 110 may include a multi-function device 112 such as a mobile device, multi-function printers, multi-function fax machines, multi-function scanners, workstation 114, or computer 116. The devices in healthcare sub-network 110 may capture, import, or process data, and they may be connected through one or more internal networks (not shown) or through communication network 102 to access services that healthcare network server 120 provides.

Healthcare network server 120 may include appropriate computer servers, software, and databases in a stand-alone configuration, a cluster configuration, a network configuration, or a cloud computing configuration. These servers may provide enterprise-wide and server-side services for processing and managing healthcare data. For example, healthcare network server 120 may include a computer server 122 with programs to communicate and exchange data with healthcare sub-network 110 to complete healthcare data-management processes.

Healthcare network server 120 may also include a storage server 124 to provide database services and database management services. Storage server 124 may store data in a central location or in a distributed storage system. Healthcare network server 120 may also communicate with other external systems (e.g., HIE 130) to exchange electronic medical records or electronic healthcare records using accepted data formats. In different environments, different types of records may be maintained and exchanges between the various systems.

HIE 130 may include appropriate computer servers, software, and databases, also in a stand-alone, cluster, network, or cloud computing configuration, and may provide various enterprise-side and server-side services for facilitating, processing, and managing healthcare data. For example, HIE 130 may include a computer server 132 and a database server 134 that includes any appropriate system in a healthcare facility or in other locations capable of receiving and processing healthcare information based on a set of standard or known protocols for healthcare professionals.

Although FIG. 1 only shows one HIE, HIE 130 may include several HIEs and even form an HIE network.

Communication network 102 may include an appropriate network for exchanging data among various devices and computer systems. For example, communication network 102 may be a telecommunication network, a wireless network, or a private and public computer network, including the Internet.

The devices and computers (e.g., multi-function devices 112, workstation 114, user computer 116, computer server 122, and computer server 132) in environment 100 may be implemented using any appropriate computing systems and other peripheral or external devices.

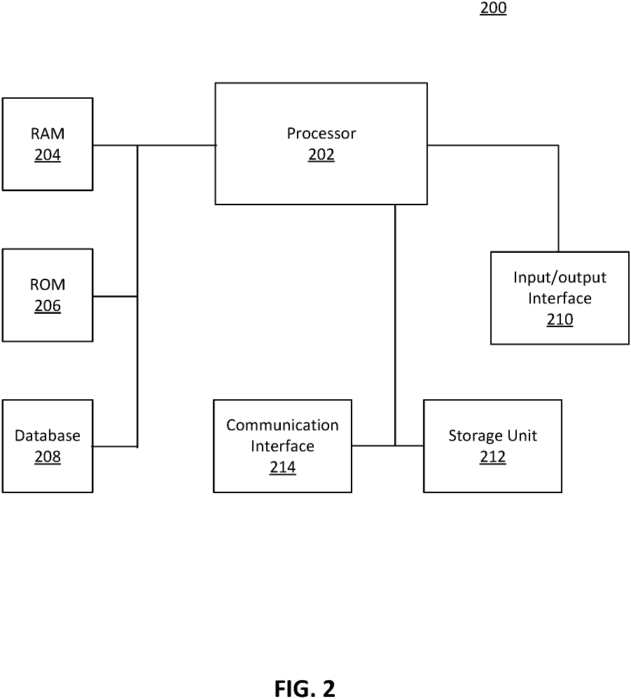

FIG. 2 shows a block diagram of an exemplary computing system 200. In FIG. 2, computing system 200 may include a processor 202, a random-access memory unit 204, a read-only memory unit 206, a database 208, an input/output interface unit 210, a storage unit 212, and a communication interface 214. Other components may be added and removed without departing from the principles of the disclosed embodiments.

Processor 202 may include any appropriate type of central processing unit (CPU), graphics processing unit (GPU), general-purpose microprocessor, digital signal processor (DSP) or microcontroller, application specific integrated circuit (ASIC), field-programmable gate array (FPGA), etc. Processor 202 may execute sequences of computer program instructions to perform various processes associated with computing system 200. The instructions may be loaded into memory 204 for execution by processor 202 using memory 206.

Database 208 may include any appropriate commercial or customized database for computing system 200 as well as query tools and other management software for managing database 208. Input/output interface 210 may be provided for users to input information into computing system 200 or receive information from computing system 200. Interface 210 may include appropriate input devices, such as a remote control, a keyboard, a mouse, a microphone, a video camera or webcam, an electronic tablet, voice communication devices, or any other optical or wireless input devices. Interface 210 may include appropriate output devices, such as a display, a speaker, or any other output devices. Interface 210 may also include external devices, such as a scanner, a camera, a fax, or a printer.

Storage unit 212 may include any appropriate storage device to store information used by computing system 200, such as a hard disk, a flash disk, an optical disk, a CD-ROM drive, a DVD-ROM drive, or other type of mass storage media, or network storage. Communication interface 214 may provide communication connections such that computing system 200 may be accessed remotely or communicate with other systems through computer networks or other communication networks via various communication protocols, such as TCP/IP, hypertext transfer protocol (HTTP), etc.

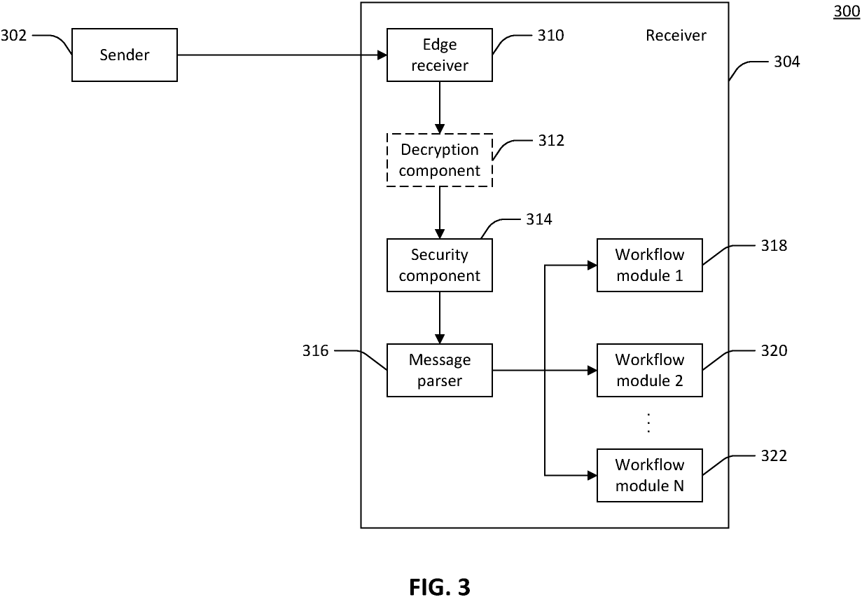

FIG. 3 is block diagram of a system 300 configured to process programming code embedded in an electronic message. The system 300 includes a sender 302 and a receiver 304. The sender 302 may include any device configured to compose and send an electronic message such as a personal computer, a mobile device, or an application running on a server and accessible by a computer or mobile device. The receiver 304 may include any device configured to receive and process an electronic message such as a server configured to process and manage large volumes of data. The sender 302 and the receiver 304 may be part of the same server (i.e., different applications running on the same virtual or physical server). The sender 302 and the receiver 304 may also exist in physically separate devices and communicate wirelessly.

A user may compose an electronic message at the sender 302. The term “electronic message” may include an email message, a direct message, or other type of electronic message. The electronic message may include a message header and a message body. The message header may include recipient information, e.g., an electronic address for the receiver 304. In some embodiments, the electronic address is specific to a particular workflow to be performed at the receiver 304. The message header may also include other information, such as information about the sender 302, a subject line, date information, a message identifier, a route taken by the electronic message from the sender 302 to the receiver 304, authentication information, or other technical information specific to a communication protocol used to deliver the electronic message to the receiver 304.

The sender 302 is configured to send to the receiver 304, an electronic message including programming code. The programming code may include information needed to invoke one or more workflows at the receiver 304. As an example, the message body may include JavaScript Object Notation (JSON) code. The electronic message may be a Secure/Multipurpose Internet Mail Extensions (S/MIME) encrypted message using a Direct profile or a “Direct Secure Message” (DSM) message body. The programming code may include any such code that may be parsed by the receiver 304 into actions or workflows for it to perform. In some embodiments, the programming code is inserted directly into the message body without the need for special tags or flags to identify the program code as such.

The sender 302 sends the electronic message to the receiver 304. The electronic message may be sent in any format compatible with both the sender 302 and the receiver 304. The receiver 304 receives the electronic message and parses the programming code in the message body. The receiver 304 may parse the programming code if it is configured to do so. If the receiver 304 is not configured to parse the programming code in the message body, the message body may appear as plaintext or “garbage” characters if displayed. In that case, nothing will happen beyond the receiver 304 receiving the electronic message.

The receiver 304 includes an edge receiver component 310, an optional decryption component 312, a security component 314, a message parser component 316, and one or more workflow modules 318, 320, 322 each configured to perform a particular workflow. Depending on the configuration of an individual workflow, one workflow may be configured to perform one or more additional workflows (i.e., the workflow initially indicated in the electronic message received from the sender 302 may “call” one or more additional workflows to complete its task(s)). While three workflow modules are shown in FIG. 3, any number of workflow modules may be included in the receiver 304. The components 310-320 may be implemented as hardware (e.g., an application specific integrated circuit (ASIC) or a field programmable gate array (FPGA)), as software, or as a combination of hardware and software.

The edge receiver component 310 is configured to determine whether the sender 302 is authorized to access the receiver 304. For example, the edge receiver component 310 may be configured to implement a certificate-based trust mechanism to determine whether the sender 302 is authorized. If the sender 302 does not have the required certificate, the edge receiver component 310 may eject the electronic message because the sender is not authorized. With such an implementation, a bad actor cannot simply send an email to the system to be processed. In other embodiments, the edge receiver component 310 may perform other types of sender authorization verification, such as a certificate-based trust mechanism or other security mechanism.

In some embodiments, trust may be established between the sender 302 and the receiver 304 by a certificate-based trust protocol. The sender 302 may be an authorized sender able to communicate with the receiver 304. If the sender 302 is not an authorized sender, the receiver 304 may ignore the electronic message or the receiver 304 may receive the electronic message but not parse it, so the body of the electronic message may appear as plaintext or “garbage” characters.

In some embodiments, the electronic message may be encrypted by the sender 302 before sending the electronic message to the receiver 304 according to any known encryption protocol. The receiver 304 may then decrypt the electronic message by a decryption component 312 (shown in FIG. 3 in dashed outline to indicate that it is an optional component). The overall operation of the system 300 does not depend on whether encryption is used or on the selection of any particular encryption protocol.

The security component 314 is configured to determine whether the sender 302 is authorized to access the requested workflow (i.e., the workflow requested by the electronic message sent by the sender 302). For example, a particular workflow (e.g., one of the workflows associated with workflow modules 318-322) is identified by the message address (e.g., the “to” address that the electronic message from the sender 302 is sent to). Access to a particular workflow may be restricted to certain senders. If the sender is authorized to access the system but not the particular workflow, then the electronic message will not be processed and will be rejected by the security component 314. For example, the receiver 304 may maintain a “whitelist” (i.e., a pre-approved list) of authorized sender addresses. The whitelist may be stored in the security component 314 or in a separate data storage accessible by the security component 314 (not shown in FIG. 3). If the sender 302 is not on the whitelist, then the electronic message may be deleted by the security component 314 (i.e., the electronic message will not be processed).

If the sender 302 is not authorized to access the workflow, then the security component 314 may store the electronic message information in an audit trail stored at the receiver 304 and the electronic message is not processed (i.e., the electronic message may be deleted by the security component 314). The audit trail may include a record of unauthorized access attempts, such as an authorized sender attempting to access an unauthorized workflow.

The message parser component 316 is configured to process the programming code in the electronic message received from the sender 302. The message parser component 316 includes the necessary intelligence to decode and process the message body contents. When the electronic message is improperly addressed, the recipient would only see “garbage” text and would not be able to process the programming code in the message body.

The message parser component 316 first determines to which workflow module 318-322 to direct the electronic message based on the address to which the electronic message was sent. In some embodiments, each workflow is associated with a specific address. For example, to invoke a secure document signing workflow, the address may be “secure_workflow@receiver.” Any suitable addressing scheme for directing the electronic message to the appropriate workflow is contemplated to be within the scope of the present disclosure.

The message parser component 316 then invokes (i.e., starts or issues a call to) the appropriate workflow 318-322 to begin processing the remainder of the message contents. Each of the workflow modules 318-322 is configured to perform a separate workflow. The workflows may communicate with each other (e.g., one workflow may “call” another workflow to perform a sub-task).

In some embodiments, the message parser component 316 may invoke a designated set of application programming interfaces (APIs) within a technology stack at the receiver 304. For example, the programming code may include API calls and directives to retrieve data to be processed according to the API calls.

With the system 300, the sender 302 does not need a sophisticated architecture to enable the initiation of complex workflows at the receiver 304. For example, an “unsophisticated” sender may interact with a “sophisticated” receiver by supporting the lowest common denominator between the sender and the receiver (e.g., by the sender including JSON in a secure message). No additional development work is required on the sender’s side. The receiver can deconstruct the electronic message and perform the necessary translations into the appropriate workflows on the receiver’s side. Additionally, the sender does not need to interact with or have a license to use an application programming interface (API) associated with the desired workflow; this is all accomplished via licenses and/or permissions on the receiver’s side.

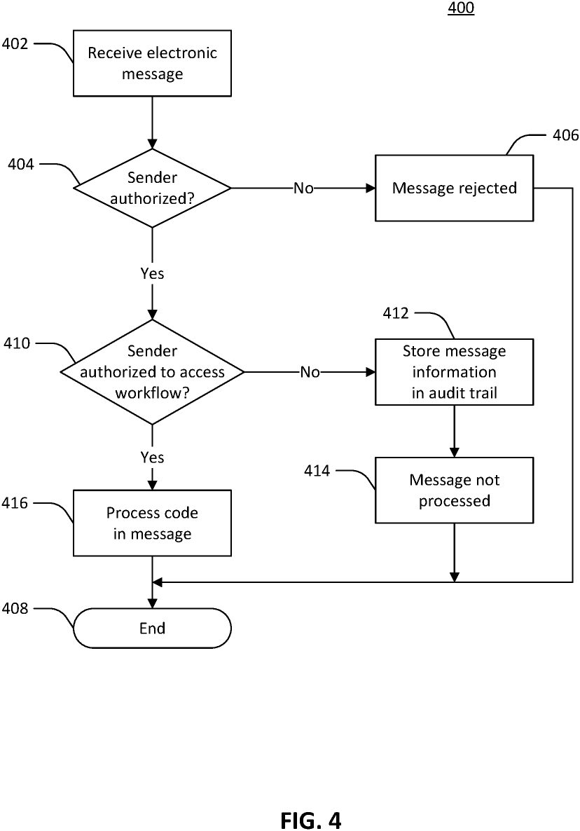

FIG. 4 is a flowchart of a method 400 for processing programming code in a body of an electronic message. The method 400 may be performed by a receiver of the electronic message (for example, receiver 304). The electronic message is received (step 402). For example, the electronic message may be an email message or a direct secure message.

A determination is made whether the sender is an authorized sender (step 404).This determination may be made by an edge receiver component in the receiver (for example, edge receiver 310) such that the message has to pass through the edge receiver before it can be processed. In one embodiment, in a healthcare setting, a health information service provider (HISP) may authorize a sender to use Direct Secure Messaging, which operates on a certificate-based trust mechanism. If the sender does not have the required certificate, the electronic message may be rejected because the sender is not an authorized user. With such an implementation, a bad actor cannot simply send an email to the system to be processed. In other embodiments, other types of sender authorization verification may be performed and may include using a certificate-based trust mechanism or other security mechanism.

If the sender is not authorized (step 404, “no” branch), then the electronic message is rejected (step 406) and the method 400 terminates (step 408). This type of message rejection may be referred to as a “hard” rejection and the receiver may not log any information about the sender. In some embodiments, the receiver may log information about the sender but not information about the electronic message. For example, the receiver may log that the sender is not an authorized sender.

If the sender is authorized (step 404, “yes” branch), then a determination is made whether the sender is authorized to access the workflow identified by the message address (e.g., the “to” address that the electronic message is sent to) (step 410). Access to a particular workflow may be restricted to certain senders. If the sender is authorized to access the system but not the particular workflow, then the electronic message will not be processed. For example, the receiver may maintain a “whitelist” of authorized sender addresses. If the sender is not on the whitelist, then the electronic message may be deleted (i.e., not processed).

If the sender is not authorized to access the workflow (step 410, “no” branch), then message information may be stored in the receiver’s audit trail (step 412) and the electronic message is not processed (i.e., the electronic message may be deleted by the receiver) (step 414). The method 400 then terminates (step 408). The audit trail may include a record of unauthorized access attempts, such as an authorized sender attempting to access an unauthorized workflow.

If the sender is authorized to access the workflow (step 410, “yes” branch), then the code in the message body is processed (step 416). The code in the message body may trigger one or more workflows to begin on the receiver side. Depending on the particulars of the workflow that is triggered, the receiver may or may not interact further with the sender. For example, the receiver may not send any response to the sender if the workflow does not require it. As another example, using a patient-signed documents example, the sender may only receive the signed documents from the patient and may not receive any indication from the receiver that the documents were sent to the patient for signature.

As another example, the electronic message may indicate a request from a doctor for records relating to a patient’s knee. The doctor’s office sends an electronic message including the request to a hospital where the patient had knee surgery performed. The hospital validates the doctor’s request (both that the doctor is an authorized sender and is authorized to request the records), retrieves its records relating to the patient’s knee surgery, packages the knee surgery records into a report, and sends the report to the doctor. The doctor’s request may involve multiple systems and internal requests on the hospital’s side, but the doctor does not need to know about how the records are retrieved on the hospital’s side to be able to receive the report. Furthermore, the doctor’s request does not need to include all the possible requests that need to be made on the hospital’s side; the workflow by design handles all the requests on the hospital’s side without needing further input from the doctor.

After the code in the message body is processed (i.e., the triggered workflow is completed), the method 400 terminates (step 408).

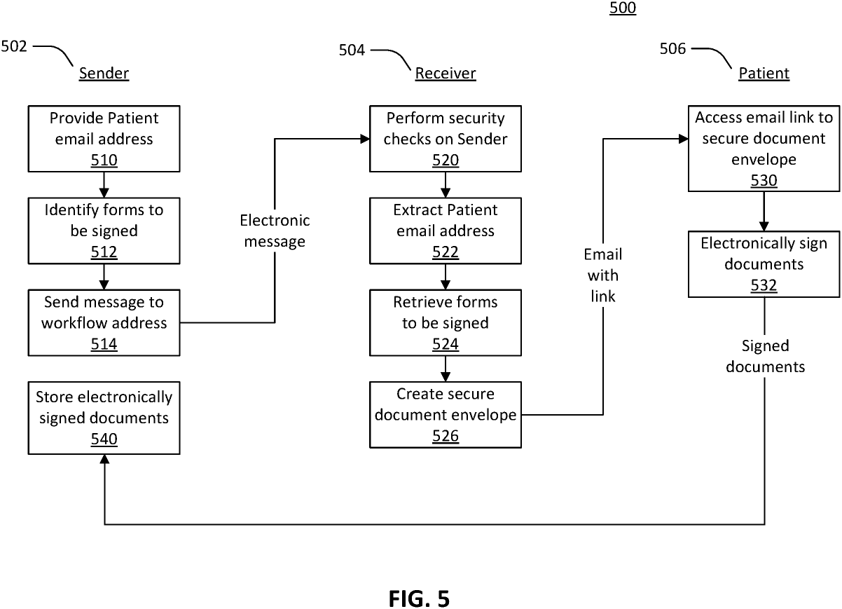

FIG. 5 is a flow diagram of a sample process 500 for processing programming code in a body of an electronic message for creating electronic documents for a patient’s signature. The process 500 describes the information flow between a sender 502, a receiver 504, and a patient 506. The sender 502 may be similar to the sender 302 and the receiver 504 may be similar to the receiver 304 described in connection with FIG. 3.

Existing tools within electronic health records (EHR) support simple consent workflows (e.g., obtaining a patient’s signature), but there is a need for more complex workflows. One exemplary implementation includes creating forms used by a healthcare provider that are automatically created, filled in, and sent to a patient for secure electronic signature. The principles of operation of the systems and methods described may apply to other industries that use automatic creation and secure transmission of documents to be completed and/or signed.

Direct Secure Messaging enables healthcare provider staff involved in a patient’s care to communicate with each other across organization and system boundaries without having to leave the platform application to print, fax, or mail materials. Any secure electronic messaging and authentication application may be used. The scope of this disclosure is not limited by the choice of secure electronic message and authentication application.

Document templates help simplify more complex workflows. In some embodiments, each unique form may be represented as a unique document type. Different document types may be classified into a hierarchy of document types. For example, a “consent” document type may include multiple consent forms that a patient needs to complete. A document template may have a single signature line with date, or multiple lines and dates. A template-level configuration allows a user to specify the number of signers, their role, the signing order, signature placement, etc.

A tool on the healthcare provider’s platform can indicate the requested template, what EHR content to retrieve, and where to place information in the template to pre-populate the form. This may be accomplished by including only a few elements, such as role, name, and email address. Data for the name element may originate dynamically from the EHR and may be selected using a user interface element, such as an auto-complete text box or a dynamic list element. The name element relating to a patient and a non-patient signer may be retrieved in a similar manner. For the email address element, the data may also originate dynamically from the EHR.

A templated block of text may be used for various types of workflows within the healthcare provider’s platform. In a workflow, the templated block of text may contain the text and templated fields for a previously detailed data concept. Additionally, the values for the elements may leverage other platform tools to populate various fields dynamically.

A templated list of choices may help users quickly select their intended customizations to the templated block of text that may have been inserted or summoned (e.g., via the template) within the platform. In a workflow, the templated list of choices may be embedded within a record to save a user the need to type “free text” into the fields while completing the form and may be presented with a list of discrete choices (e.g., the templated list of choices).

Discrete and dynamic links may retrieve information from the patient’s chart or from EHR into the templated block of text. The dynamic links may add a dynamic quality to a templated block of text. In a workflow, the dynamic links may insert relevant patient-specific or signer-specific information into the data structure of the template.

The sender 502 creates an electronic message, including an email address of the patient 506 (step 510) and identifying the forms that the patient 506 is to sign (step 512). In the message body, the employee selects the patient to receive the document package, for example using a patient lookup tool or a search function.

The message body may include templated text to trigger additional processing when the electronic message is received and processed by the document creation tool. The message body may also include a document template name and signer information. The signer information may include the signer type (e.g., patient or legal representative), the signer’s role, the signer’s name, and the signer’s email. Multiple signers may be similarly identified in the message body if needed.

In one scenario with a single signer (patient), various templates and dynamic links can dynamically populate an entire message body.

For example, a templated form may be coded as follows:

{
“templates”: [
{
“templateName”: “{Template:RecordIDGoesHere}”
}
],
“signers”: [
{
“role”: “Patient”,
“name”: “@DynamicDataGoesHere@”,
“email”: “@DynamicDataGoesHere@”
}
]
}

Once the user fills in the template fields (e.g., via a user interface), the message body may be generated as the following code:

{
“templates”: [
{
“templateName”: “Consent for Outpatient Services”
}
],
“signers”: [
{
“role”: “Patient”,
“name”: “TestPatient”,
“email”: “testpatient@email.com”
}
]
}

This code may be inserted in the message body and may be parsed by a receiver to perform a workflow to create the document titled “Consent for Outpatient Services” to be signed by TestPatient and emailed to the address testpatient@email.com without further actions required by the user.

In another scenario involving multiple templates and multiple signers (e.g., a patient and the patient’s legal representative), the entire message body may also be dynamically populated using various templates and dynamic links.

For example, consider the following template code for documents requiring two signatures:

{
“templates”: [
{
“templateName”: “{Template: RecordlDGoesHere}”
},
{
“templateName”: “{Template:RecordIDGoesHere}”
}
],
“signers”: [
{
“role”: “Patient”,
“name”: “@DynamicDataGoesHere@”,
“email”: “@DynamicDataGoesHere@”
},
{
“role”: “Legal Representative”,
“name”: “@DynamicDataGoesHere@”,
“email”: “@DynamicDataGoesHere@”
}
]
}

Once the user fills in the template fields, the message body may be generated as the following code:

{
“templates”: [
{
“templateName”: “Consent for Inpatient Services”
},
{
“templateName”: “Informed consent for Blood or Blood Products”
}
],
“signers”: [
{
“role”: “Patient”,
“name”: “TestPatient”,
“email”: “testpatient@email.com”
},
{
“role”: “Legal Representative”,
“name”: “TestPatient Representative”,
“email”: “witness@email.com”
}
]
}

This code may be inserted in the message body and may be parsed by a receiver to perform a workflow to create two documents, titled “Consent for Inpatient Services” and “Informed consent for Blood or Blood Products,” to be signed by TestPatient and TestPatient Representative and emailed to the addresses testpatient@email.com and witness@email.com without further actions required by the user.

The sender 502 may create the electronic message using a message creation tool, such as an email application, an email feature of a comprehensive application, a messaging application, or a messaging feature of a comprehensive application. The sender 502 indicates the address for the desired workflow (in the process 500, a secure document creation workflow) in the electronic message and sends the electronic message to the workflow address (step 514).

The receiver 504 receives the electronic message and performs security checks on the sender 502 (step 520). The security checks include whether the sender 502 is an authorized sender and authorized to access the desired workflow. The security checks are similar to those described above in steps 404-406 and 410-414 of method 400.

If the sender 502 passes the security checks, then the receiver 504 begins parsing the electronic message. The secure document creation workflow processes the templated text to extract the document template name and the signer information, and creates a secure digital signature document envelope. The email address of the patient 506 is extracted from the electronic message (step 522).

The documents indicated by the document template name are created and any necessary fields are automatically populated with information pulled from the EHR corresponding to the signer identified in the message body. The forms to be signed by the patient 506 that are identified in the message body are retrieved (step 524). In some embodiments, retrieving the forms to be signed may be performed by one workflow or may be performed by invoking one or more additional workflows. Once all the identified forms have been retrieved, the receiver 504 creates a secure document envelope to package the forms together (step 526). The receiver 504 then sends an email message to the patient 506. The email message may include the secure document envelope (e.g., as an attachment to the message) or a hyperlink to enable the patient 506 to access the secure document envelope. For purposes of discussion of the process 500, it is assumed that the message to the patient 506 includes a hyperlink to access the secure document envelope.

The patient 506 activates the hyperlink in the email message to access the secure document envelope (step 530). The patient 506 electronically signs the documents in the secure document envelope (step 532). Once the patient 506 has signed all the documents in the secure document envelope, the documents are automatically sent to the sender 502. The sender 502 receives the electronically signed documents and may store the documents (step 540). The healthcare information provider’s systems may open the secure signature document envelope and process the documents as if the signer had “wet signed” the documents in person in the healthcare provider’s office.

The patient 506 does not need to take any steps to return the electronically signed documents to the sender 502; this is part of the workflow that the sender 502 initiated by sending the electronic message to the receiver 504. In some embodiments, the patient 506 may receive an electronic receipt that the sender 502 has received the signed documents.

Other embodiments of the invention will be apparent to those skilled in the art from consideration of the specification and practice of the invention disclosed herein. The specification and examples are only exemplary, with the true scope of the invention being indicated by the following claims.

What is claimed is:

1. A method for a receiver device to process programming code contained in an electronic message, the method comprising:
receiving the electronic message;
performing a security check, including:
determining whether a sender of the electronic message is an authorized sender; and
determining whether the sender is authorized to access one or more workflows identified by an address of the electronic message; and
on a condition that the security check passes:
parsing the programming code; and
performing the one or more workflows identified by the address of the electronic message at the receiver device based on the programming code.

2. The method of claim 1, wherein:
the security check is based on a certificate-based trust mechanism; and
the sender is determined to be an authorized sender on a condition that the sender possesses a valid certificate.

3. The method of claim 1, further comprising:
rejecting the message on a condition that the sender is not determined to be an authorized sender.

4. The method of claim 1, wherein the sender is authorized to access the one or more identified workflows on a condition that the sender is on a pre-approved list.

5. The method of claim 1, further comprising:
storing message information in an audit trail on a condition that the sender is not determined to be authorized to access the one or more workflows.

6. The method of claim 1, wherein parsing the programming code includes invoking one or more application programming interfaces.

7. The method of claim 1, wherein the electronic message is encrypted and the method further comprises:
decrypting the electronic message before parsing the programming code.

8. A receiver device for processing programming code contained in an electronic message, comprising:
a receiving component configured to receive the electronic message;
a security component configured to perform a security check, wherein the security component is configured to:
determine whether a sender of the electronic message is an authorized sender; and
determine whether the sender is authorized to access one or more workflows identified by an address of the electronic message; and
a parsing component configured to, on a condition that the security check passes:
parse the programming code; and
perform the one or more identified workflows based on the programming code.

9. The receiver device of claim 8, wherein the security component is further configured to:
use a certificate-based trust mechanism to determine whether the sender is authorized.

10. The receiver device of claim 8, wherein on a condition that the sender is not determined to be an authorized sender, the receiving component is further configured to:
reject the message.

11. The receiver device of claim 8, wherein the security component is further configured to:
determine the sender is authorized to access the identified workflow on a condition that the sender is on a pre-approved list.

12. The receiver device of claim 8, wherein the security component is further configured to:
store message information in an audit trail on a condition that the sender is not determined to be authorized to access the one or more workflows.

13. The receiver device of claim 8, wherein the parsing component is configured to parse the programming code by invoking one or more application programming interfaces.

14. The receiver device of claim 8, wherein the electronic message is encrypted and the receiver device further comprises:
a decryption component configured to decrypt the electronic message before the parsing component parses the programming code.

15. A non-transitory computer-readable medium storing instructions for execution by one or more processors to perform operations for processing programming code contained in an electronic message by a receiver device, the operations comprising:
receiving the electronic message;
performing a security check, including:
determining whether a sender of the electronic message is an authorized sender; and
determining whether the sender is authorized to access one or more workflows identified by an address of the electronic message; and
on a condition that the security check passes:
parsing the programming code; and
performing the one or more workflows identified by the address of the electronic message at the receiver device based on the programming code.

16. The non-transitory computer-readable medium of claim 15, wherein:
the security check is based on a certificate-based trust mechanism; and
the sender is determined to be an authorized sender on a condition that the sender possesses a valid certificate.

17. The non-transitory computer-readable medium of claim 15, wherein the operations further comprise:
rejecting the message on a condition that the sender is not determined to be an authorized sender.

18. The non-transitory computer-readable medium of claim 15, wherein the sender is authorized to access the one or more identified workflows on a condition that the sender is on a pre-approved list.

19. The non-transitory computer-readable medium of claim 15, wherein the operations further comprise:
storing message information in an audit trail on a condition that the sender is not determined to be authorized to access the one or more workflows.

20. The non-transitory computer-readable medium of claim 15, wherein the electronic message is encrypted and the operations further comprise:
decrypting the electronic message before parsing the programming code.
